(19) United States
(12) Patent Application Publication
(10) Pub. No.: US 2007/0080691 A1
(43) Pub. Date: Apr. 12, 2007

(54) Testing and comparing two batteries connected in parallel method and apparatus

(75) Inventor: Dennis Robinson II, Portage, MI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/204,354

(22) Filed: Aug. 16, 2005

(51) Int. Cl. G01N 27/416

(52) U.S. Cl. 324/426

(57) ABSTRACT

In accordance with some embodiments of the present invention, a battery testing apparatus and method include a processor, a first clamp coupled to the processor, a second clamp coupled to the processor, and a third clamp coupled to the processor wherein the processor is configured to collect data on a current flow when the first and second clamps are connected with a first battery and the third clamp is connected to a conductor connecting the first battery with a second battery connected to the first battery in parallel. The processor is further configured to process the data to determine whether the first battery is stronger than, weaker than or the same capacity as the second battery.

### FIELD OF THE INVENTION

The present invention relates generally to battery testers. More particularly, the present invention relates to testing which of two batteries connected in parallel is weaker.

### BACKGROUND OF THE INVENTION

Batteries are an important part of a motor vehicle's operation. The emergence of hybrid vehicles and the general trend towards finding alternate sources of energy to replace fossil fuels, means batteries are gaining even greater importance.

A number of individual batteries may be arranged in such a way as to offer more power than an individual battery would on its own. However, power stored in batteries dissipates over time. Therefore, battery testers are used to test power stored a in battery.

The batteries may have to be removed from a vehicle or wherever the batteries are deployed. This poses several problems to the technician testing the batteries. The batteries may be positioned in an awkward manner or may be difficult to access. Further, the batteries may need to be tested individually. Then the technician must reinstall the batteries. These steps expend valuable time and subsequently increase maintenance cost. There may also be an instance where, the technician has spent time removing, testing and reinstalling batteries that were not weak, that needed no maintenance.

The conventional method of testing batteries in a battery pack was inconvenient and tedious because the battery pack had to be disconnected or removed and the batteries separately tested. This posed additional problems in that the batteries may have corroded or may have leaked. The terminals may also have been stripped. Often the location of the battery was difficult to reach and the disassembly of the batteries was even more difficult. Thus, these situations may cause serious injury to a technician working on these batteries.

Accordingly, it is desirable to provide an apparatus and method that allows a user to determine the strength of a battery without having to remove the battery. Also, it is desirable to provide a simple, cost effective, and efficient manner of determining which battery in a battery pack is weakest and therefore, needs to be either recharged or replaced.

### SUMMARY OF THE INVENTION

The foregoing needs are met, to a great extent, by the present invention, wherein in one aspect an apparatus is provided that in some embodiments the battery testing apparatus or method of the present invention provides an easy and convenient way to determine which of the batteries in a battery pack is faulty.

In accordance with one embodiment of the present invention, a battery testing apparatus includes a processor, a first clamp coupled to the processor, a second clamp coupled to the processor, and a third clamp coupled to the processor wherein the processor is configured to collect data on a current flow when the first and second clamps are connected with a first battery and the third clamp is connected to a conductor connecting the first battery with a second battery connected to the first battery in parallel. The processor is further configured to process the data to determine whether the first battery is stronger than, weaker than or the same capacity as the second battery.

In accordance with another embodiment of the present invention, a method of testing a battery includes, connecting a first clamp coupled to a processor, to a positive battery terminal of a first battery, connecting a second clamp coupled to the processor to a negative battery terminal of the first battery, and connecting a third clamp coupled to the processor to a conductor connecting the first battery to a second battery wherein the first battery and the second battery are connected in parallel.

In accordance with yet another embodiment of the present invention, a system for testing a battery includes a first clamping means operably connecting a processing means to a positive battery terminal of a first battery, a second clamping means operably connecting the processing means to a negative battery terminal of the first battery, and a third clamping means operably connecting the processing means to a conductor connecting the first battery to a second battery wherein the first battery and the second battery are connected in parallel.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating two batteries connected in parallel and to a load.

FIG. 2 is a perspective view of a battery testing apparatus according to an embodiment of the invention.

FIG. 3 is a schematic diagram of one configuration of testing two batteries connected in parallel and to a load.

FIG. 4 is a schematic diagram of a second configuration of testing two batteries connected in parallel and to a load.

FIG. 5 is a flowchart illustrating the steps that may be followed in accordance with an embodiment of the invention.

### DETAILED DESCRIPTION

The invention will now be described with reference to the drawing figures, in which like reference numerals refer to like parts throughout. An embodiment in accordance with the present invention provides an apparatus and method that allows a user to determine which of a battery in a battery pack is weakest without having to remove the batteries in the battery pack. A battery pack may include several individual batteries connected in parallel or in series. In some embodiments of the present invention, the battery pack includes two batteries connected in parallel. A simple, cost effective, and efficient manner of determining which battery in the battery pack needs to be either recharged, replaced, or otherwise maintained is provided. The apparatus and method of this invention are particularly useful where there are two batteries connected in parallel.

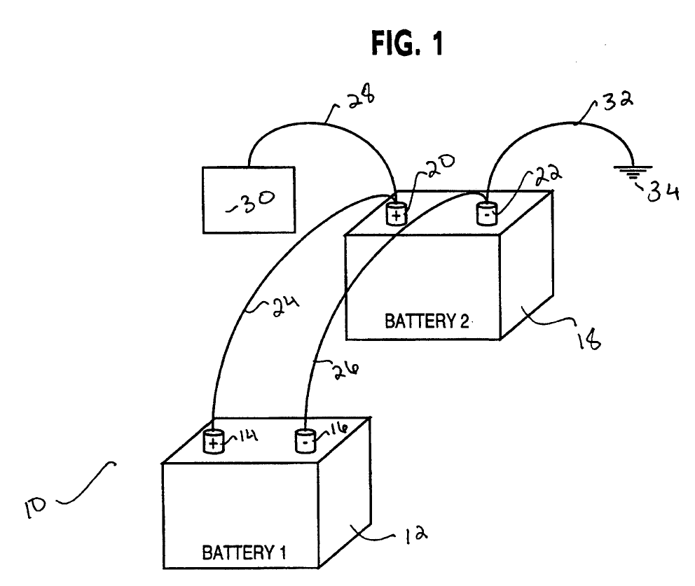

FIG. 1 is a perspective view illustrating a battery pack 10 with two batteries 12 and 18 connected in parallel and to a load. This configuration may be found in an electric powered car for example. In other embodiments of the present invention, the battery pack 10 may be used in vehicles that require two batteries to provide the cranking capacities to start a fuel burning engine. A battery pack 10 as illustrated may be used in sport utility vehicles, pickup trucks, diesel engines, or a variety of larger vehicles because they require more power to crank the engine than smaller automotive vehicles. The additional batteries provide the cranking capacities that are required by these larger vehicles. A first battery 12 has a positive terminal 14 and a negative terminal 16. The first battery 12 is connected in parallel to a second battery 18 having a positive terminal 20 and a negative terminal 22.

The positive terminal 14 of the first battery 12 is connected to the positive terminal 20 of the second battery 18 by cable 24. Likewise, the negative terminal 16 of the first battery 12 is connected to the negative terminal 22 of the second battery 18 by a cable 26. A connection 28 couples the battery pack 10 to a fuse box 30 that supplies power to an automotive vehicle engine (not shown). A connection 32 couples the battery pack 10 to ground 34. Ground 34 in this case may be a vehicle's chassis or the negative terminal of an electric engine.

Connection 28 couples the battery pack 10 to the fuse box 30 by connecting the positive terminal 20 of the second battery 18 to the fuse box 30. Likewise, connection 32 couples the battery pack 10 to ground 34 by connecting ground 34 to the negative terminal 22 of the second battery 18. Connections 28 and 32 may be any type of cables or connectors as may be desired. Other suitable connection schemes may also be used in accordance with the invention.

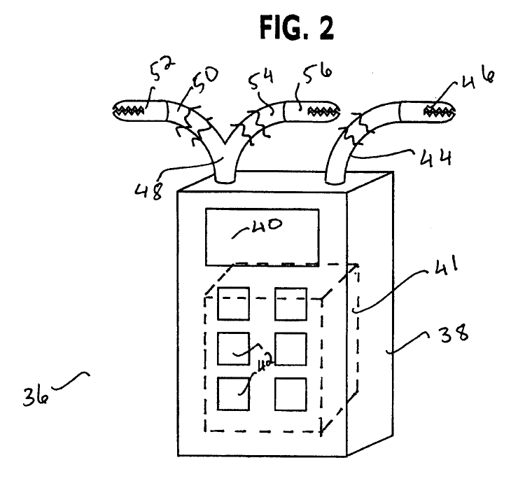

FIG. 2 is a perspective view of a battery testing apparatus 36 according to an embodiment of the present invention. The battery testing apparatus 36 contains a housing 38, a display 40, an internal processor 41 and an input device 42. The input device 42 may be any type of device, such as buttons, dials or a keyboard. Thus, any manner by which a user can enter information may be used.

A cable 44 extends from the housing 38 and is configured to measure a current flow in the battery pack 10 using an amprobe clamp 46. The apparatus 36 also contains cables 48. A first testing cable 50 is configured to couple to the positive terminal 14 of a battery 12 using a battery clamp 52. Likewise, a second testing cable 54 is configured to couple to the negative terminal 16 of a battery using a battery clamp 56.

Alternatively, cable 50 may connect to a negative terminal 22 of a battery 18, and cable 54 may connect to a positive terminal 20 of a battery 18. The clamps 52 or 56 of the battery testing apparatus 36 that couple to the positive or negative terminal of a battery may be alligator clamps or any suitable type of attaching device. Although shown as a separate device, the battery testing apparatus 36 may be combined with any type of electrical device such as an automotive scan tool or an amprobe, for example.

The display 40 is configured to show step-by-step detailed instructions and is driven by the processor 41. These instructions will instruct the technician on where and when to attach a particular clamp or when to remove a particular clamp. The display 40 also shows the results of the current measurements as well as the determination of which battery is the weaker of the two.

The display 40 may be a Liquid Crystal Display (LCD) or the like. The LCD may show letters and numbers. A Video Graphics Array (VGA) display will be able to show images instead of characters. The display 40 may include either an LCD screen, a VGA screen or a combination of both.

The battery testing device 36 also includes an internal processor 41. The processor 41 is configured to record and then analyze the current measurements. The processor 41 also determines which of the batteries is weaker. The processor 41 is also programmed with software to make the determination of which battery is weaker. The processor 41 will be explained in more detail below.

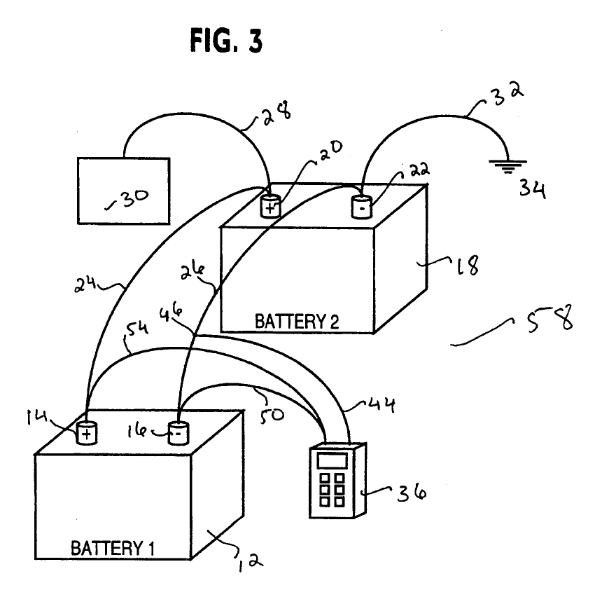

FIG. 3 is a schematic diagram of one configuration 58 of testing two batteries 12 and 18 connected in parallel and to a load. The battery testing apparatus 36 is now shown to test the batteries 12 and 18. The testing cable 50 is coupled to the negative terminal 16 of the first battery 12 and testing cable 54 is coupled to the positive terminal 14 of the first battery 12. The amprobe clamp 46 is coupled to the cable 26 that connects the negative terminal 16 of the first battery 12 to the negative terminal 22 of the second battery 18. In this manner, the amprobe clamp 46 can detect the current flowing between the first battery 12 and the second battery 18. Typical amprobes measure induced current.

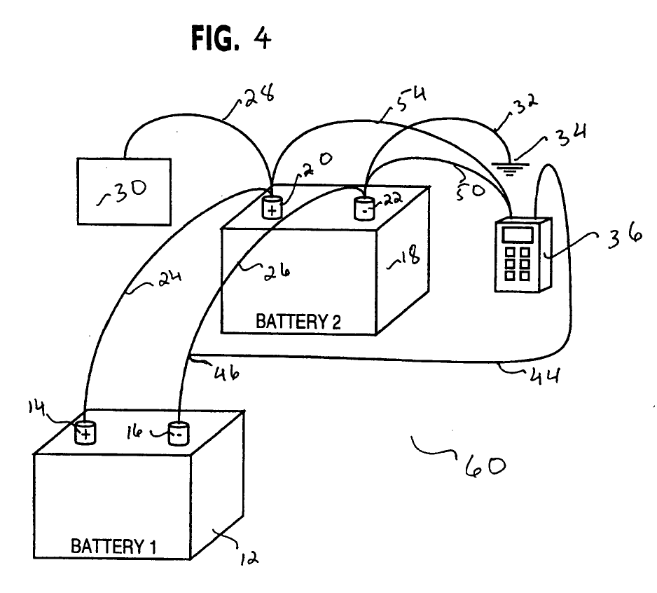

FIG. 4 is a perspective view of a second configuration 60 of testing two batteries 12 and 18 connected in parallel and to a load. The second configuration 60 shows the battery testing device 36 in a slightly different manner. The testing cable 50 now couples to the negative terminal 22 of the second battery 18 while the testing cable 54 couples to the positive terminal 20 of the second battery 18. The amprobe clamp 46 continues to couple to the cable 26 that connects the negative terminal 16 of the first battery 12 to the negative terminal 22 of the second battery 18. Once again the current flow between the first battery 12 and the second battery 18 is measured.

Connecting the amprobe clamp 46 between the batteries 12 and 18 and loading the two batteries 12 and 18 one at a time determines that the battery that exhibits the higher absolute amp flow when loaded, is the weaker of the two batteries 12 and 18. The test is integrated in a battery tester 36 and produces a diagnostic result upon completion of the test procedure.

A load is provided by the battery testing device 36, whereby the batteries testing device 36 shorts out the battery 12 or 18. (The battery testing device 36 simulates the cranking capacity that is found when an engine is turned on.)

The battery testing device 36 allows for determining which of the batteries 12 and 18 in a battery pack 10 is faulty without having to disconnect and remove the batteries 12 and 18 from the battery pack 10. This battery testing device 36 has the ability to provide a load as well as the ability to measure current flow. The battery testing device 36 measures a voltage drop and provides a determination of the condition of the batteries 12 and 18.

When there are two batteries 12 and 18 in a battery pack 10 and one of the batteries is weaker than the other battery, the stronger battery will attempt to compensate for the weaker battery. This is seen by a current flow flowing from the strong battery to the weak battery. This current flow may be measured using an amprobe.

If the two batteries 12 and 18 are equally strong or equally weak, little or no current will flow and the batteries 12 and 18 may be disassembled from their location and separately tested using any suitable battery testing device. The battery testing apparatus will measure a zero or low reading and the display will read out zero or low amps.

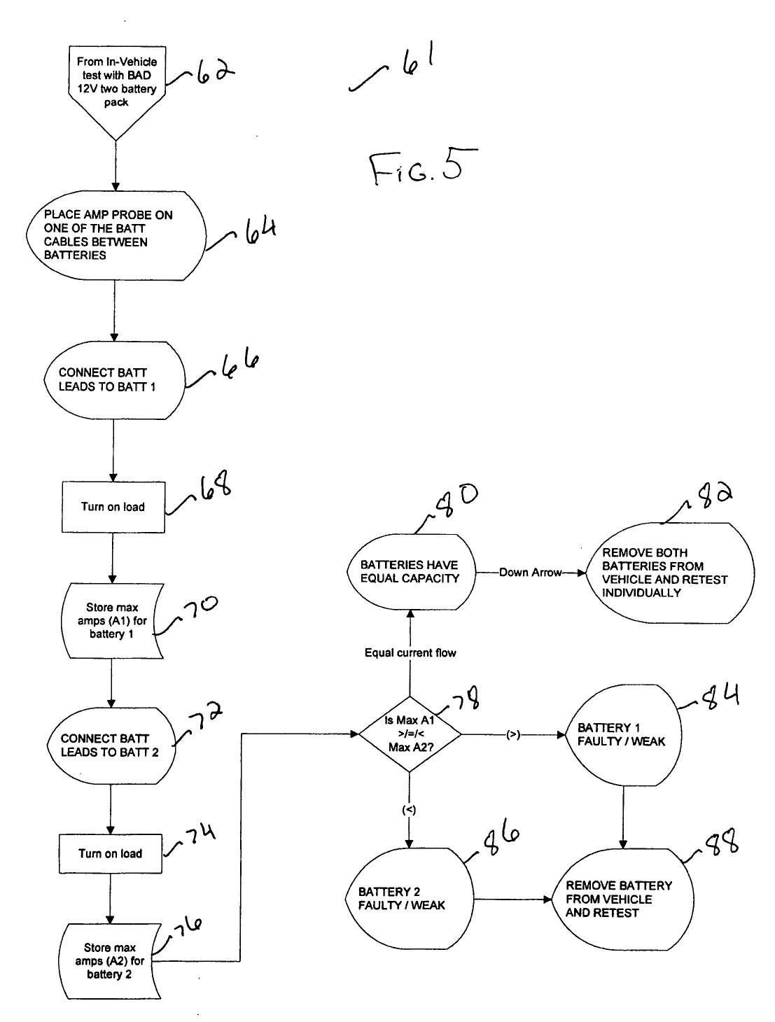

FIG. 5 is a flowchart illustrating the steps that may be followed in accordance with an embodiment of the present invention. The steps of the test 61 are begun where there is a battery pack with two batteries placed in parallel 62. Next, an amprobe is placed on one of the battery cables 64 between the first battery and the second battery.

The technician is instructed by the apparatus to connect the battery leads to the first battery 66. Software installed in the processor 41 contains these instructions and will allow for them to be displayed on the display 40. A message will appear on the display instructing the technician with next steps. A first load is then provided by the battery testing apparatus 68. The apparatus then records the maximum current flow between the two batteries 70, labeling this first measurement A1. The technician is then instructed by the apparatus to connect the battery leads to the second battery 72. The apparatus provides a second load 74. The apparatus then records the maximum current flow between the two batteries 76, labeling this second measurement A2.

The apparatus then evaluates which of the batteries is faulty. The apparatus determines 78 whether A1 is equal to, greater than or less than A2. If A1 is equal to A2, the batteries have equal capacity 80; both are equally strong or equally weak. For instance, if the technician knows that the batteries were recently replaced or recharged, the technician may choose to leave the batteries in place, knowing that the batteries are equally strong. The technician may also determine in this way that neither battery is losing its power at a disproportionate rate. However, both batteries are tested individually 82, if the technician wishes to obtain additional information.

If A1 is greater than A2, the apparatus displays to the technician that the first battery is deemed faulty or weak 84. Alternatively, if A1 is less than A2, the apparatus indicates that the second battery is weak 86. The faulty battery may then be removed 88. This battery may then be tested using other types of testers to obtain additional information about the battery. The weak battery may also be recharged or replaced with a new battery.

A technician connects the amprobe to either cable connecting the two batteries. The polarity and current flow direction may be in either direction. Thus, the current flow direction is not important for the amprobe feature because it is an absolute reading. A technician would leave the amprobe connected during the test and move the battery clamps from the terminals of the first battery to the second battery when instructed by the battery tester.

If the first battery, when loaded, has more measured current flow than the second battery when loaded, then the first battery is determined to be weak. If the second battery, when loaded, has more measured current flow then the first battery, when loaded, then the second battery is determined to be weak. If the current flow is equal to, or close to being equal, the battery capacities are basically the same and the technician will have to remove the battery and test them separately to obtain additional information.

Although, the battery testing apparatus has been shown in conjunction with automobile vehicles, the battery testing device may also be used with any kind of power system having batteries and a battery pack such as any backup power system. Backup power systems are often used in a radio or cellular telephone towers, security systems for buildings, railroad crossing signs or where uninterrupted power supplies are required.

The battery testing apparatus may be used with rechargeable or non rechargeable batteries. The battery testing apparatus may be used for absorbed glass mat, or AGM batteries. This device may also be used for flooded lead acid batteries. Preferably the batteries being tested have identical voltages. In particular the device may be used for batteries having voltages in the range of 6-36 volts.

An embodiment of the present invention may easily be utilized by anyone. The battery testing apparatus need not be used solely by an automotive technician performing repairs on the vehicle. Rather, this apparatus is user friendly and may easily be used by a driver of the vehicle.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A battery testing apparatus comprising:
a processor;
a first clamp coupled to the processor;
a second clamp coupled to the processor; and
a third clamp coupled to the processor wherein the processor is configured to collect data on a current flow when the first and second clamps are connected with a first battery and the third clamp is connected to a conductor connecting the first battery with a second battery connected to the first battery in parallel, the processor further configured to process the data to determine whether the first battery is stronger than, weaker than or the same capacity as the second battery.

2. The apparatus of claim 1, wherein the processor is configured for the first clamp to couple to a positive terminal of the first battery, the second clamp to couple to a negative terminal of the first battery.

3. The apparatus of claim 1, wherein the apparatus is configured to provide a load.

4. The apparatus of claim 1, wherein the third clamp is configured to measure the current flow.

5. The apparatus of claim 4, wherein the processor records a first current flow associated with the first battery and records a second current flow associated with the second battery.

6. The apparatus of claim 4, wherein the processor analyzes the first and second current flows to determine whether the first battery is stronger than, weaker than or the same as the second battery

7. The apparatus of claim 1, wherein the third clamp is an amprobe clamp.

8. The apparatus of claim 1, wherein the first and the second clamps are alligator clamps.

9. A method of testing a battery comprising:
connecting a first clamp coupled to a processor to a positive battery terminal of a first battery;
connecting a second clamp coupled to the processor to a negative battery terminal of the first battery; and
connecting a third clamp coupled to the processor to a conductor connecting the first battery to a second battery wherein the first battery and the second battery are connected in parallel.

10. The method of claim 9, further comprising the step of providing a first load to the first battery.

11. The method of claim 9, further comprising the step of analyzing with the processor a first current flow between the first battery and the second battery.

12. The method of claim 11, wherein the processor records the first current flow as a first value.

13. The method of claim 9, further comprising the step of connecting the first clamp to a positive terminal of the second battery; and
connecting the second clamp to a negative terminal of the second battery.

14. The method of claim 9, further comprising the step of providing a second load to the second battery.

15. The method of claim 9, further comprising the step of analyzing with the processor a second current flow between the first battery and the second battery.

16. The method of claim 15, wherein the processor records the second current flow as a second value.

17. The method of claim 9, further comprising the step of analyzing the first and the second current flows with the processor to determine whether the first battery is stronger than, weaker than or has the same capacity as the second battery.

18. The method of claim 17, wherein the processor determines whether the first value is greater than, less than or equal to the second value.

19. A system for testing a battery comprising:
a first clamping means operably connecting a processing means to a positive battery terminal of a first battery;
a second clamping means operably connecting the processing means to a negative battery terminal of the first battery; and
a third clamping means operably connecting the processing means to a conductor connecting the first battery to a second battery wherein the first battery and the second battery are connected in parallel and the processing means measures and records a first current flow between the first battery and the second battery.

20. The system of claim 19, further comprising
the first clamping means operably connecting the processing means to a positive terminal of the second battery;
the second clamping means operably connecting the processing means to a negative battery terminal of the second battery; and
the third clamping means operably connecting the processing means to the conductor connecting the first battery to the second battery and the processing means measures and records a second current flow between the first battery and the second battery.

21. The system of claim 19, further comprising the processing means analyzing the first and the second current flows to determine whether the first battery is stronger than, weaker than or has the same capacity as the second battery.
